(19) United States
(12) Patent Application Publication
(10) Pub. No.: US 2008/0170072 A1
(43) Pub. Date: Jul. 17, 2008

(54) IMAGE DISPLAY APPARATUS AND IMAGE DISPLAY METHOD THEREOF

(75) Inventor: Sang-hoon KANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/942,829

(22) Filed: Nov. 20, 2007

(30) Foreign Application Priority Data
Jan. 11, 2007 (KR) 10-2007-0003511

(51) Int. Cl. G09G 5/00

(52) U.S. Cl. 345/428

(57) ABSTRACT

An image display apparatus including: a memory unit which stores at least one predetermined pixel value range and a representative value corresponding to the predetermined pixel value range; an image processing unit which receives an image signal including a plurality of pixels, digitizes the received image signal if the received image signal is an analog signal, substitutes the representative value for a pixel value of one of the digitized image signal and the received image signal if the pixel value of the one of the digitized image signal and the received image signal is included within the predetermined pixel value range, and generates a substituted pixel value which corresponds to the substituted representative value; and a display unit which displays an image based on the substituted pixel value generated by the image processing unit.

### CROSS-REFERENCE TO RELATED APPLICATIONS

This application claims priority from Korean Patent Application No. 10-2007-0003511, filed on Jan. 11, 2007 in the Korean Intellectual Property Office, the disclosure of which is incorporated herein by reference.

### BACKGROUND OF INVENTION

1. Field of Invention

Apparatuses and methods consistent with the present invention relate to an image display apparatus, and more particularly, to an image display apparatus for converting an image signal to 6-bit gradated digital image data, and an image display method thereof.

2. Description of the Related Art

Image display apparatuses such as a cathode ray tub (CRT) have evolved into various image display apparatuses such as a liquid crystal display (LCD) and a plasma display panel (PDP). The image display apparatus will be further developed to have higher efficiency with lower power.

Improved images may be provided as the image display apparatus is developed, but its cost is still high. Accordingly, it is desired to reduce the number of display colors for each pixel, so that the cost of the image display apparatus may be reduced. When the number of display colors for each pixel is reduced, there is a result wherein problems of heat and electromagnetic interference may be minimized.

However, when an analog image signal is converted to a digital image signal, a noise in the analog image signal or noises caused by various factors are amplified through a frame rate control (FRC) process and a dithering process, so that the noise may be perceived by a user.

When an image signal received from an external signal source such as a computer is an analog signal, the image display apparatus converts the analog image signal to the digital image signal by an analog-to-digital converter (ADC). In addition, a sampling and a quantization process are performed when the analog signal is converted to the digital signal, and in this case, an error of the input signal is directly provided to the digital image signal through the ADC. In addition, the image display apparatus for respectively converting colors (e.g., red (R), green (G), and blue (B)) forming pixel values of the analog image signal into a digital image signal gradated in 8 bits, converts the 8-bit gradated digital image signal into a 6-bit digital image signal. The noise generated in the process for converting the analog image signal to the digital image signal is still inserted to the 6-bit gradation digital image signal, and the noise is amplified when the 6-bit image signal is processed for the FRC and dithering, and therefore may be perceived by the user.

Accordingly, there is a problem in that the noise becomes more obvious as a gradation value of the 8-bit gradated digital image signal approaches a higher value.

### SUMMARY OF THE INVENTION

Accordingly, an aspect of the present invention provides an image display apparatus for eliminating a noise inserted while image-processing an image signal received from an external signal source, and an image display method thereof.

The foregoing and/or other aspects of the present invention can be achieved by providing an image display apparatus comprising: a memory unit which stores at least one predetermined pixel value range and a representative value corresponding to the predetermined pixel value range; an image processing unit which receives an image signal including a plurality of pixels, digitizes the received image signal if the received image signal is an analog signal, substitutes the representative value for a pixel value of one of the digitized image signal and the received image signal if the pixel value of the one of the digitized image signal and the received image signal is included within the predetermined pixel value range, and generates a substituted pixel value which corresponds to the substituted representative value; and a display unit which displays an image based on the substituted pixel value generated by the image processing unit.

According to an aspect of the invention, a minimum value of the predetermined pixel value range is a minimum pixel value of a pixel at which a user perceives a noise from the displayed image, and the representative value is the same as a maximum value of the predetermined pixel value range.

According to an aspect of the invention, the pixel value corresponding to the image displayed by the display unit is calculated by reducing number of bits of the substituted pixel value generated by the image processing unit.

According to an aspect of the invention, the pixel value generated by the image processing unit is a pixel value calculated in 8 bits, and the pixel value corresponding the image displayed by the display unit is a pixel value calculated in 6 bits.

According to an aspect of the invention, the display unit forms a plurality of pixels as one unit, and performs frame rate control and dithering for the pixels in each unit.

According to an aspect of the invention, the pixel comprises at least one color of a plurality of colors.

According to an aspect of the invention, the image processing unit comprises an analog/digital (A/D) converter, the A/D converter performs the digitizing of the analog signal by converting the analog signal to a digital signal, if the image signal received by the image processing unit is the analog signal; and the A/D converter substitutes the representative value for the pixel value, if the pixel value of the one of the digitized image signal is included within the predetermined pixel value range.

The foregoing and/or other aspects of the present invention can be achieved by providing an image display apparatus comprising: a memory unit which stores at least one predetermined pixel value range and a representative value corresponding to the predetermined pixel value range; an image processing unit which receives an image signal including a plurality of pixels, and digitizes the received image signal if the received image signal is an analog signal; an image controlling unit which substitutes the representative value for a pixel value of one of the digitized image signal and the received image signal if a pixel value of the of the one of the digitized image signal and the received image signal is included within the predetermined pixel value range and outputs a substituted pixel value based on the substitution of the representative value; and a display unit which displays an image based on the substituted pixel value.

According to an aspect of the invention, a minimum value of the predetermined pixel value range is a pixel value of a pixel at which a user perceives a noise from the displayed image, and the representative value is the same as a maximum value of the predetermined pixel value range.

According to an aspect of the invention, the pixel value corresponding to the image displayed by the display unit is calculated by reducing number of bits of the pixel value calculated by the image processing unit.

According to an aspect of the invention, the pixel value generated by the image processing unit is a pixel value calculated in 8 bits, and the pixel value corresponding to the image displayed by the display unit is a pixel value calculated in 6 bits.

According to an aspect of the invention, the display unit forms a plurality of pixels as one unit, and performs frame rate control (FRC) and dithering for the pixels in each unit.

According to an aspect of the invention, the pixel comprises at least one color of a plurality of colors.

According to an aspect of the invention, the image processing unit further comprises an analog/digital (A/D) converter, the A/D converter converting an analog signal to a digital signal an image of the converted digital signal if the image signal received by the image processing unit is the analog signal.

The foregoing and/or other aspects of the present invention can be achieved by providing an image display method of an image display device, the method comprising: (a) receiving an image signal including a plurality of pixels; (b) generating a digitized signal if the received image signal is an analog signal; (c) determining whether a pixel value of one of the received image signal and the digitized signal is included within a predetermined pixel value range; (d) substituting a representative value corresponding to the predetermined pixel value range for the pixel value of the one of the received image signal and the digitized signal, to generate a substituted pixel value, if a pixel value of the one of the received image signal and the digitized signal is included within the predetermined pixel value range; (e) reducing a number of bits of the substituted pixel value by the representative value; (f) generating a display image signal by performing frame rate control (FRC) and dithering for the bit-reduced image signal; and (g) displaying an image of the display image signal.

According to an aspect of the invention, the operation (b) further comprises converting an analog signal to a digital signal if the received image signal is the analog signal.

According to an aspect of the invention, the pixel value of the one of the received image signal and the digitized image signal in operation (c) is of an 8-bit gradation, and the pixel value of the image displayed in the operation (g) is a pixel value obtained by performing the FRC and dithering for the 6-bit gradation value which is bit-reduced in the operation (e).

According to an aspect of the invention, a minimum value of the predetermined pixel value range is a pixel value of a pixel at which a user perceives a noise from the displayed image, and the representative value is the same as a maximum value of the predetermined pixel value range.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram of an image display apparatus according to a first exemplary embodiment of the present invention;

FIG. 2 is a block diagram of the image display apparatus according to a second exemplary embodiment of the present invention; and

FIG. 3 is a flowchart representing an image display method of the image display apparatus according to the first and second exemplary embodiments of the present invention.

### DETAILED DESCRIPTION OF EXEMPLARY EMBODIMENTS OF THE INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

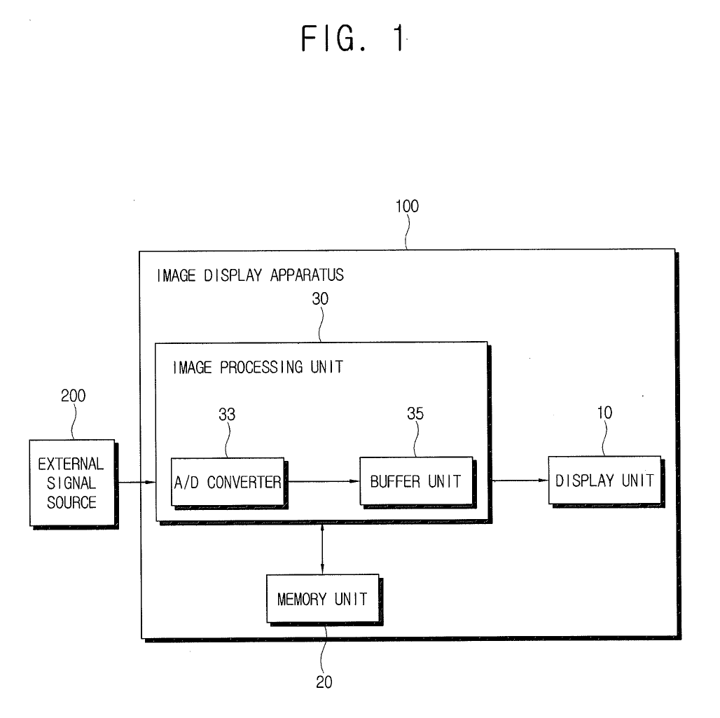

FIG. 1 is a block diagram of an image display device according to a first exemplary embodiment of the present invention.

As shown in FIG. 1, the image display apparatus 100 according to the first exemplary embodiment of the present invention includes a display unit 10, a memory unit 20, and an image processing unit 30.

The memory unit 20 stores at least one predetermined pixel value range and a representative value corresponding to the pixel value range. Here, if there is a plurality of predetermined pixel value ranges, the memory unit 20 stores a table including the plurality of predetermined pixel value ranges and representative values corresponding to the predetermined pixel value ranges.

The image processing unit 30 receives an image signal including a plurality of pixels from an external signal source 200, processes an image of a digital image signal when the received image signal is the digital image signal, and transmits the processed digital image signal to the display unit 10. When the image signal received from the external signal source 200 is an analog image signal, the image processing unit 30 performs sampling and quantization processes for the analog image signal to convert the analog image signal to the digital image signal. The image processing unit 30 processes the image of the digital image signal and determines whether a pixel value of the digital image signal lies within the predetermined pixel value range stored in the memory unit 20. In this case, when the pixel value of the digital image signal is included within the predetermined pixel value range, the image processing unit 30 substitutes the representative value corresponding to the predetermined pixel value range for the pixel value of the digital image signal, and transmits the digital image signal to the display unit 10.

The image processing unit 30 further includes an analog/digital (A/D) converter 33 and a buffer unit 35.

The A/D converter 33 converts the analog image signal into the digital image signal when receiving the analog image signal from the external signal source 200. In this case, the A/D converter 33 performs the sampling and quantization processes for the analog signal to covert the analog signal to the digital signal. The A/D converter 33 converts the analog image signal to the digital image signal having a plurality of bits (e.g., 8 bits) while sampling and quantizing the analog signal.

When the A/D converter 33 converts the analog signal to an 8-bit digital signal, the converted digital signal has a value in a range of 0 to 255. Here, the values 0 to 255 are gradation values obtained by respectively converting R, G, and B analog signals to 8-bit gradated digital signals.

The buffer unit 35 stores the pixel value of the image signal converted to the 8-bit gradated digital signal by the A/D converter 33.

The image processing unit 30 reads the pixel value of the digital image signal converted to the 8-bit digital signal by the A/D converter 33 from the buffer unit 35 to determine whether the pixel value is included in the predetermined pixel range stored in the memory unit 20, substitutes the representative value corresponding to the predetermined pixel value range for the pixel value when the pixel value is included in the predetermined pixel value range, and transmits the representative value to the display unit 10. Here, when comparing the pixel value of the digital image signal with the predetermined pixel value range, the image processing unit 30 determines whether the colors (e.g., R, G, and B) forming the pixel value are respectively included in the predetermined pixel value range. The pixel values (R, G, and B) of one pixel may be respectively expressed as a number between 0 and 255.

The display unit 10 displays an image based on the pixel value of the 8-bit gradated digital image signal received from the image processing unit 30.

The pixel value of the image displayed on the display unit 10 is less than the pixel value received from the image processing unit 30. That is, after reducing the pixel value of the 8-bit gradated digital image signal received from the image processing unit 30 to the pixel value of the 6-bit digital image signal, the display unit 10 displays the image based on the pixel value of the 6-bit digital image signal.

The display unit 10 displays the pixel value of the bit-reduced digital image signal through a frame rate control (FRC) process and a dithering process.

The pixel value of the 8-bit gradated digital image signal transmitted from the image processing unit 30 to the display unit 10 has a pixel range of 0 to 255 for the respective R, G, and B. Accordingly, the number of colors that may be displayed in one pixel by the pixel values of the 8-bit gradated digital image signal transmitted from the image processing unit 30 to the display unit 10 is approximately 16,700,000 (=256×256×256). However, when the display unit 10 reduces the number of bits of the pixel value of the 8-bit gradated digital image signal received from the image processing unit 30 to 6 bits, and the bit-reduced digital image signal is processed for the FRC and the dithering, the pixel value of the image displayed on the display unit 10 has the pixel value range of 0 to 252 for the respective R, G, and B. Accordingly, the number of colors that may be displayed in one pixel by the bit-reduced digital image signal is approximately 16,200,000 (=253×253×253).

Since the FRC and dithering are performed by the display unit 10 to form a block of a plurality of pixels and alternately turn on and off the pixels of the block, a difference between the numbers of displayed colors due to the bit-reduction may be compensated.

The image display apparatus 100 according to the first exemplary embodiment of the present invention will now be described in further detail.

The memory unit 20 stores the predetermined pixel value range and the representative value corresponding to the predetermined pixel value range. In this case, when there is a plurality of predetermined pixel values, the memory unit 20 stores a table including the plurality of predetermined pixel value ranges and the representative values corresponding to the pixel value ranges. Table 1 is an example of the table including the plurality of predetermined pixel value ranges and the representative values corresponding to the pixel value ranges stored in the memory unit 20.

TABLE 1

| Predetermined pixel value range | Representative value |
|---|---|
| 252-255 | 255 |
| 248-251 | 251 |
| 244-247 | 247 |

The image processing unit 30 receives the image signal from the external signal source 200 such as a computer. The received signal may be an analog signal or a digital signal. When the received image signal is the analog signal, the image processing unit 30 converts the image signal to the digital signal through sampling and quantization processes. When the received image signal is the digital signal, the sampling and the quantization processes are omitted.

The image processing unit 30 may further include the A/D converter 33 and the buffer unit 35.

When receiving the analog signal from the external signal source 200, the A/D converter 33 samples the analog signal and performs the quantization process in a pulse code modulation (PCM) method to convert the analog signal to the digital image signal. For example, when the analog signal is quantized as 8 bits, the digital image signal is an 8-bit gradated image signal. Accordingly, the pixel value of the digital image signal has a value within a range of 0 to 255 for the respective R, G, and B. That is, the pixel values (R, G, and B) of the digital image signal respectively have the values between 0 and 255.

The noise is inserted to the digital image signal by the sampling and quantization processes for converting the analog signal to the digital signal by the A/D converter 33. The noise affects a gradation value of the digital image signal generated by the A/D converter 33. That is, when at least one of the R, G, and B forming the pixel value of the analog image signal is a full-color and the analog image signal is converted to the digital signal, the full-color has a gradation value of 255 which is a maximum value of 8-bit gradation. However, the actual gradation value has a value less than 255 by the noise (e.g., 253 or 252). Here, the gradation difference may be caused by the noise inserted in the analog signal or the noise provided by other factors. The noise may be amplified in image displaying processes including the FRC and the dithering, and the noise may be displayed along with the image on the display unit 10.

The A/D converter 33 stores the image signal converted from the analog signal to the digital signal in the buffer unit 35.

The image processing unit 30 uses Table 1 stored in the memory unit 20 to determine whether the pixel value of the digital image signal stored in the buffer unit 35 is included in the predetermined pixel value range of Table 1, and substitutes the representative value of the predetermined pixel value range for the pixel value when the pixel value is included in the predetermined pixel value range. For example, when the pixel values of the digital image signal are respectively 100, 150, and 254 for the respective R, G, and B, the image processing unit 30 changes the pixel values to 100, 150, and 255. That is, 255 is substituted for the 8-bit gradation value 254 for the color B. In addition, when the pixel values of the digital image signal are respectively 254, 252, and 249 for the respective R, G, and B, the image processing unit 30 changes the pixel values to 255, 255, and 251, respectively. That is, the image processing unit 30 substitutes 255, 255, 251 for the 8-bit gradation values 254, 252, and 249 for the respective R, G, and B with reference to Table 1 of the memory unit 20.

In this case, the image processing unit 30 may substitute the gradation value, and the A/D converter 33 included in the image processing unit 30 may also substitute the gradation value.

The image processing unit 30 converts the analog image signal into the 8-bit gradated digital image signal, determines whether the pixel value of the digital image signal is substituted by the representative value stored in the memory unit 20, and transmits the digital image signal to the display unit 10.

When the image signal transmitted from the external signal source 200 to the image processing unit 30 is the digital signal, the process for converting the analog signal to the digital signal by the A/D converter 33 is omitted, and the processed image signal is transmitted to the display unit 10.

The display unit 10 receives the 8-bit gradated digital image signal from the image processing unit 30, and converts it to the 6-bit digital image signal. That is, the pixel value of the 8-bit digital image signal received from the image processing unit 30 has a number between 0 and 255 for the respective R, G, and B, and the pixel value of the bit-reduced digital image signal has a number between 0 and 252 through the FRC and dithering processes. Accordingly, the number of colors that may be realized by the pixel value of the digital image signal received by the display unit 10 is approximately 16,700,000 (=256×256×256), and the number of colors that may be displayed by the pixel value of the digital image signal displayed on the display unit 10 is approximately 16,200,000 (253×253×253). The gradation level of the 8-bit digital image signal received from the image processing unit 30 by the display unit 10 is 256, and the gradation level of the digital image signal changed to 6 bits by the display unit 10 is 64. In this case, the gradation level 64 of the 6-bit converted digital image signal may have 253 gradation values through the FRC and dithering processes.

In the FRC process, one pixel is turned on and off during a plurality of frames to obtain an intermediate gradation of the gradations of pixels between the frames.

In the dithering process, a plurality of pixels is configured as one group, and an average value of values obtained by turning on and off the respective pixels is used to determine the intermediate gradation.

The display unit 10 can have the values 0 to 252 by performing the FRC and dithering processes for the values 0 to 63 of the respective R, G, and B forming the pixel of the digital image signal.

Since the display unit 10 expresses 252 for the pixel value of the full-color (e.g., full red, full green and full blue) of the digital image signal received from the image processing unit 30 (252 is the maximum color value that may be expressed in the display unit 10), the noise displayed together when the image is displayed may be eliminated.

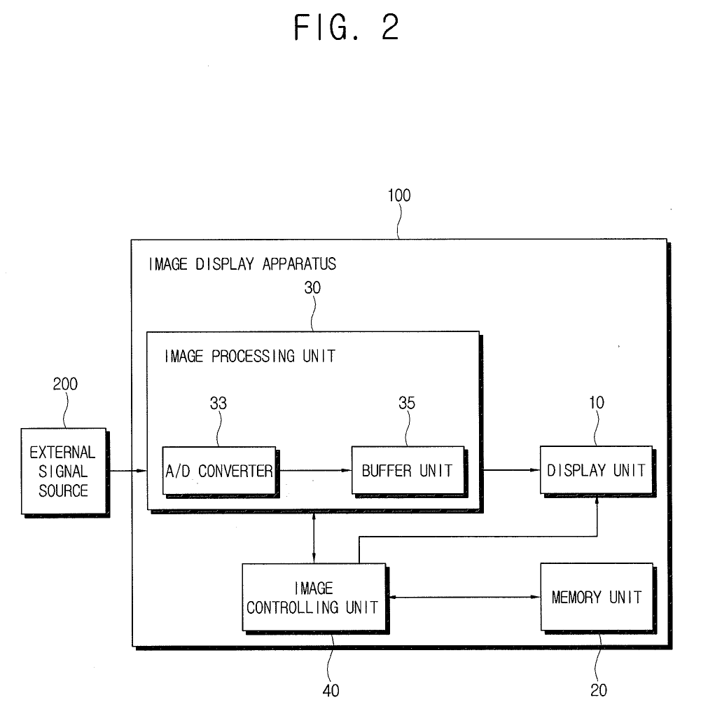

FIG. 2 is a block diagram of the image display apparatus according to a second exemplary embodiment of the present invention.

As shown in FIG. 2, the image display apparatus 100 according to the second exemplary embodiment of the present invention includes the image processing unit 30, the memory unit 20, the display unit 10, and an image controlling unit 40.

The memory unit 20 and the display unit 10 in the image display apparatus 100 according to the second exemplary embodiment of the present invention are the same as those shown in FIG. 1, and therefore detailed descriptions thereof will be omitted.

The A/D converter 33 and the buffer unit 35 in the image processing unit 30 shown in FIG. 2 are the same as those shown in FIG. 1, and therefore detailed descriptions thereof will be omitted.

The image processing unit 30 stores the gradation value of the digital image signal converted by the A/D converter 33 in the buffer unit 35.

The image controlling unit 40 compares the pixel value of the digital image signal of the buffer unit 35 with the predetermined pixel value range stored in the memory unit 20. In this case, the image controlling unit 40 may directly read the pixel value of the digital image signal from the buffer unit 35, or may request the image processing unit 30 to transmit the pixel value to the image controlling unit 40. When the pixel value is included in predetermined pixel value range, the image controlling unit 40 substitutes the representative value of the predetermined pixel value range for the pixel value stored in the buffer unit 35. In this case, the image controlling unit 40 may directly store the representative value in the buffer unit 35, or may transmit the representative value to the image processing unit 30 so that the image processing unit 30 stores it in the buffer unit 35.

The image processing unit 30 transmits the digital image signal substituted by the image controlling unit 40 to the display unit 10.

In this case, the digital image signal transmitted to the display unit 10 may be transmitted by the image processing unit 30 or by the image controlling unit 40.

If the image controlling unit 40 has read the pixel value of the digital image signal from the buffer unit 35, has searched for the predetermined pixel value range from Table 1 stored in the memory unit 20, has substituted the representative value corresponding to the predetermined pixel value range for the pixel value, and has stored the representative value in the buffer unit 35, the image processing unit 30 transmits the pixel value of the digital image signal substituted by the image controlling unit 40 to the display unit 10.

In addition, the image controlling unit 40 may read the pixel value of the digital image signal from the buffer unit 35, search for the predetermined pixel value range from Table 1 of the memory unit 20, substitute the representative value corresponding to the predetermined pixel value range for the pixel value, and directly transmit the substituted pixel value of the digital image signal to the display unit 10.

The image processing unit 30 and the image controlling unit 40 are respectively different processors. However, functions of the image processing unit 30 and the image controlling unit 40 may be performed by one integrated processor. An example of the integrated processor is the image processing unit 30 in the image display apparatus 100 shown in FIG. 1.

As shown in FIG. 2, when the two processors of the image processing unit 30 and the image controlling unit 40 are provided, the image processing unit 30 includes a scaler for processing an input image, and the image controlling unit 40 corresponds to a main processor unit (MPU) for controlling the image processing unit 30, the memory unit 20, and the display unit 10.

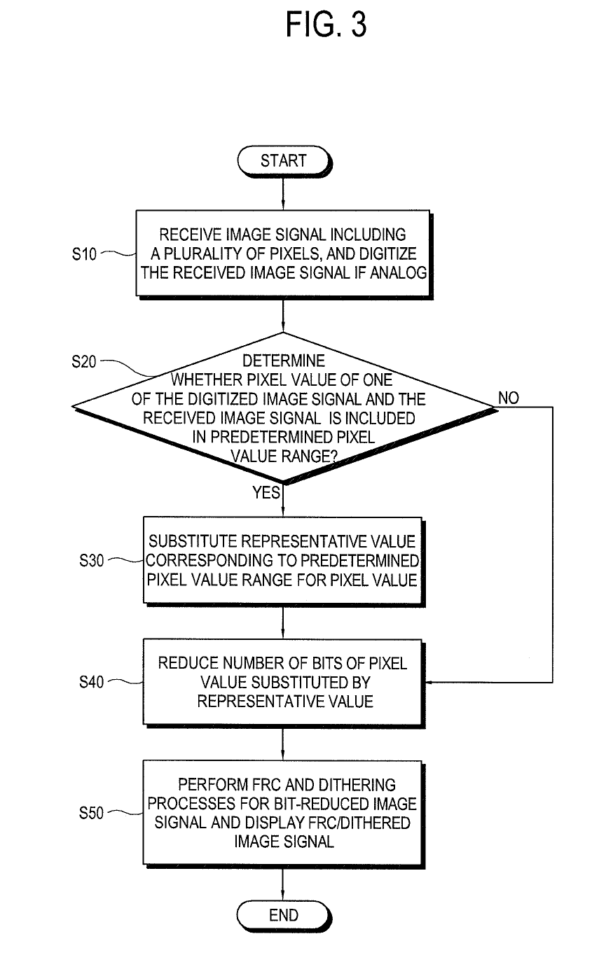

FIG. 3 is a flowchart representing an image display method of the image display apparatus 100 according to the first and second exemplary embodiments of the present invention.

As shown in FIG. 3, in the image display method of the image display apparatus 100 according to the exemplary embodiments of the present invention, an image signal including a plurality of pixels is received and if the received image signal is an analog signal, the received signal is digitized at operation S10. It is determined at operation S20 whether the pixel value of one of the received image signal and the digitized image signal is included within the predetermined pixel value range. When it is included within the predetermined pixel value range, the representative value corresponding to the predetermined pixel value range is substituted for the pixel value at operation S30. The pixel value substituted by the representative value is bit-reduced at operation S40. The bit-reduced pixel value is processed for the FRC and dithering to be displayed on the display unit 10 at operation S50.

When the received image signal is an analog signal at operation S10, the analog signal is converted into a digital signal.

The pixel value of the image at operation S20 is of an 8-bit gradation, and the pixel value displayed at operation S50 is a pixel value obtained by performing the FRC and dithering processes for the 6-bit gradation value which is bit-reduced at operation S40.

Here, the minimum value of the predetermined pixel value range is a pixel value of a pixel at which a user perceives the noise from the displayed image, and the representative value is the same as the maximum value of the predetermined pixel value range.

As described above, in the image display apparatus according to the exemplary embodiments of the present invention and the image display method thereof, the image signal received from the external signal source is processed, the noise exposed in the process for displaying the processed image is eliminated, and therefore an improved image may be provided.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image display apparatus comprising:
a memory unit which stores at least one predetermined pixel value range and a representative value corresponding to the predetermined pixel value range;
an image processing unit which receives an image signal including a plurality of pixels, digitizes the received image signal if the received image signal is an analog signal, substitutes the representative value for a pixel value of one of the digitized image signal and the received image signal if a pixel value of the one of the digitized image signal and the received image signal is included within the predetermined pixel value range, and generates a substituted pixel value which corresponds to the substituted representative value; and
a display unit which displays an image based on the substituted pixel value.

2. The image display apparatus of claim 1, wherein a minimum value of the predetermined pixel value range is a minimum pixel value of a pixel at which a user perceives a noise from the displayed image, and the representative value is a maximum value of the predetermined pixel value range.

3. The image display apparatus of claim 1, wherein a display pixel value corresponding to the image displayed by the display unit is calculated by reducing a number of bits of the substituted pixel value.

4. The image display apparatus of claim 3, wherein the substituted pixel value is calculated in 8 bits, and the display pixel value corresponding to the image displayed by the display unit is calculated in 6 bits.

5. The image display apparatus of claim 1, wherein the display unit forms a plurality of pixels as one unit, and performs frame rate control and dithering for the plurality of pixels in the unit.

6. The image display apparatus of claim 5, wherein the pixel comprises at least one color of a plurality of colors.

7. The image display apparatus of claim 6, wherein the image processing unit comprises an analog/digital (A/D) converter which performs the digitizing of the analog signal by converting the analog signal to a digital signal, if the received image signal is the analog signal; and the A/D converter substitutes the representative value for the pixel value of the digitized image signal, if the pixel value of the digitized image signal is included within the predetermined pixel value range.

8. An image display apparatus comprising:
a memory unit which stores at least one predetermined pixel value range and a representative value corresponding to the predetermined pixel value range;
an image processing unit which receives an image signal comprising a plurality of pixels, digitizes the received image signal if the received image signal is an analog signal;
an image controlling unit which substitutes the representative value for a pixel value of one of the digitized image signal and the received image signal if a pixel value of the one of the digitized image signal and the received image signal is included within the predetermined pixel value range and outputs a substituted pixel value based on the substitution of the representative value; and
a display unit which displays an image based on the substituted pixel value.

9. The image display apparatus of claim 8, wherein a minimum value of the predetermined pixel value range is a minimum pixel value of a pixel at which a user perceives a noise from the displayed image, and the representative value is a same as a maximum value of the predetermined pixel value range.

10. The image display apparatus of claim 8, wherein a pixel value corresponding to the image displayed by the display unit is calculated by reducing a number of bits of the substituted pixel value.

11. The image display apparatus of claim 10, wherein the substituted pixel value generated by the image processing unit is calculated in 8 bits, and the pixel value corresponding to the image displayed by the display unit is calculated in 6 bits.

12. The image display apparatus of claim 8, wherein the display unit forms a plurality of pixels as one unit, and performs frame rate control (FRC) and dithering for the plurality of pixels in the unit.

13. The image display apparatus of claim 12, wherein the pixel comprises at least one color of a plurality of colors.

14. The image display apparatus of claim 13, wherein the image processing unit further comprises an analog/digital (A/D) converter which performs the digitizing of the analog signal, by converting the analog signal to a digital signal, if the received image signal is the analog signal.

15. An image display method of an image display device, the method comprising:
(a) receiving an image signal including a plurality of pixels;
(b) determining whether a pixel value of one of the received image signal and a digitized signal is included within a predetermined pixel value range;
(c) substituting a representative value corresponding to the predetermined pixel value range for the pixel value of the one of the received image signal and the digitized signal, to generate a substituted pixel value, if a pixel value of the one of the received image signal and the digitized signal is included within the predetermined pixel value range;
(d) reducing a number of bits of the substituted pixel value by the representative value;
(e) generating a display image signal by performing frame rate control (FRC) and dithering for the bit-reduced image signal; and
(f) displaying an image of the display image signal.

16. The image display method of claim 15 further comprising generating the digitized signal if the received image signal is an analog signal;

17. The image display method of claim 15, wherein the pixel value of the one of the digitized image signal and the received image signal in operation (b) is of an 8-bit gradation, and a pixel value of the image displayed in operation (f) is obtained by performing the FRC and dithering for a 6-bit gradation value which is bit-reduced in operation (d).

18. The image display method of claim 15, wherein a minimum value of the predetermined pixel value range is a minimum pixel value of a pixel at which a user perceives a noise from the displayed image, and the representative value is a same as a maximum value of the predetermined pixel value range.
